(19) United States
(12) Patent Application Publication
(10) Pub. No.: US 2024/0328574 A1
(43) Pub. Date: Oct. 3, 2024

(54) AUXILIARY MOUNTING DEVICE AND MOUNTING SYSTEM

(71) Applicant: Wistron NeWeb Corporation, Hsinchu (TW)

(72) Inventors: Chih-Jen LAI, Hsinchu (TW); Yu-Shuo WU, Hsinchu (TW)

(21) Appl. No.: 18/619,498

(22) Filed: Mar. 28, 2024

(30) Foreign Application Priority Data
Mar. 31, 2023 (TW) 112112391

(51) Int. Cl. F16M 13/02

(52) U.S. Cl. CPC F16M 13/02

(57) ABSTRACT

An auxiliary mounting device is configured for coupling to a housing and includes a first engaging element, a second engaging element and a connecting mechanism. The first engaging element has a first engaging region. The second engaging element corresponds to the first engaging element and has a second engaging region. The connecting mechanism is connected to the first engaging element and the second engaging element and configured for being detachably fixed on a surface of the housing. There is a constricting gap between the first engaging region and the second engaging region, and the first engaging region and the second engaging region divide a hole of the housing into an installing space and a constricting space.

### RELATED APPLICATIONS

This application claims priority to Taiwan Application Serial Number 112112391, filed Mar. 31, 2023, which is herein incorporated by reference.

### BACKGROUND

### Technical Field

The present disclosure relates to an auxiliary device. More particularly, the present disclosure relates to an auxiliary mounting device and a mounting system that assists a housing to be fixed to a mounting member.

### Description of Related Art

With the advancement of technology, miniaturized devices such as small switches have been widely used in people's lives. In order to facilitate the installation of a device, relevant industries provide a wall mounting hole on a housing of the device for a rod to pass through for installation so as to install the device on the wall. However, because the device is only suspended on the rod by the wall mounting hole, when the device is shaken by an external force, such as an earthquake or the user accidentally hits the device, the rod cannot provide a stable support on a release direction of the wall mounting hole and the device, so the device is prone to fall off from the rod. Therefore, the support provided by the conventional device is limited when it is installed on the wall in a wall-mounted manner.

In view of this, an auxiliary mounting device and a mounting system that can assist a device to be fixed to a rod are the goals to be achieved by the relevant industries.

### SUMMARY

According to one aspect of the present disclosure, an auxiliary mounting device includes a first engaging element, a second engaging element and a connecting mechanism. The first engaging element has a first engaging region for partially covering a hole of a housing, and the second engaging element corresponds to the first engaging element and has a second engaging region for partially covering the hole of the housing. The connecting mechanism is connected to the first engaging element and the second engaging element and for being detachably fixed on a surface of the housing. The first engaging region and the second engaging region divide the hole into an installing space and a constricting space. The installing space is communicated with the constricting space through a constricting gap between the first engaging region and the second engaging region, and the installing space is larger than the constricting space. When the first engaging region and the second engaging region are expanded in opposite directions due to an external force, a width of the constricting gap is changed from a first width to a second width.

According to another aspect of the present disclosure, a mounting system includes a housing and an auxiliary mounting device. The housing includes a surface and a hole disposed on the surface of the housing. The auxiliary mounting device includes a first engaging element, a second engaging element and a connecting mechanism. The first engaging element has a first engaging region for partially covering the hole of the housing, and the second engaging element corresponds to the first engaging element and has a second engaging region for partially covering the hole of the housing. The connecting mechanism is connected to the first engaging element and the second engaging element and is for being detachably fixed on the surface of the housing. The first engaging region and the second engaging region divide the hole into an installing space and a constricting space, the installing space is communicated with the constricting space through a constricting gap between the first engaging region and the second engaging region, and the installing space is larger than the constricting space. When a mounting member passes through and is disposed in the installing space and is moved relative to the housing along an installing direction, the first engaging region and the second engaging region are expanded in opposite directions due to an external force, and a width of the constricting gap is changed from a first width to a second width. The first width is smaller than a diameter of the mounting member, the second width is greater than or equal to the diameter of the mounting member, so the mounting member passes through the constricting gap, and the mounting member is constricted to the constricting space after the first engaging region and the second engaging region resume.

### BRIEF DESCRIPTION OF THE DRAWINGS

The present disclosure can be more fully understood by reading the following detailed description of the embodiment, with reference made to the accompanying drawings as follows:

FIG. 1 is a schematic exploded view of an auxiliary mounting device according to a first embodiment of the present disclosure coupled to a housing.

FIG. 2 is a schematic view of the auxiliary mounting device according to the first embodiment of FIG. 1 coupled to a surface of the housing.

FIG. 3 is a schematic view of the auxiliary mounting device according to the first embodiment of FIG. 1 coupled to the housing and constricting a mounting member.

FIG. 4 is a schematic cross-sectional view along Line 4-4 of the auxiliary mounting device according to the first embodiment of FIG. 3.

FIG. 5 is a schematic cross-sectional view along Line 5-5 of the auxiliary mounting device according to the first embodiment of FIG. 3.

FIG. 6 is a schematic exploded view of an auxiliary mounting device according to a second embodiment of the present disclosure coupled to a housing.

FIG. 7 is a schematic view of the auxiliary mounting device according to the second embodiment of FIG. 6 coupled to the housing and constricting a mounting member.

FIG. 8 is a schematic exploded view of an auxiliary mounting device according to a third embodiment of the present disclosure coupled to a housing.

FIG. 9 is a schematic view of the auxiliary mounting device according to the third embodiment of FIG. 8 coupled to the housing and constricting a mounting member.

FIG. 10 is a three-dimensional schematic view of a mounting system according to a fourth embodiment of the present disclosure constricting a mounting member.

### DETAILED DESCRIPTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

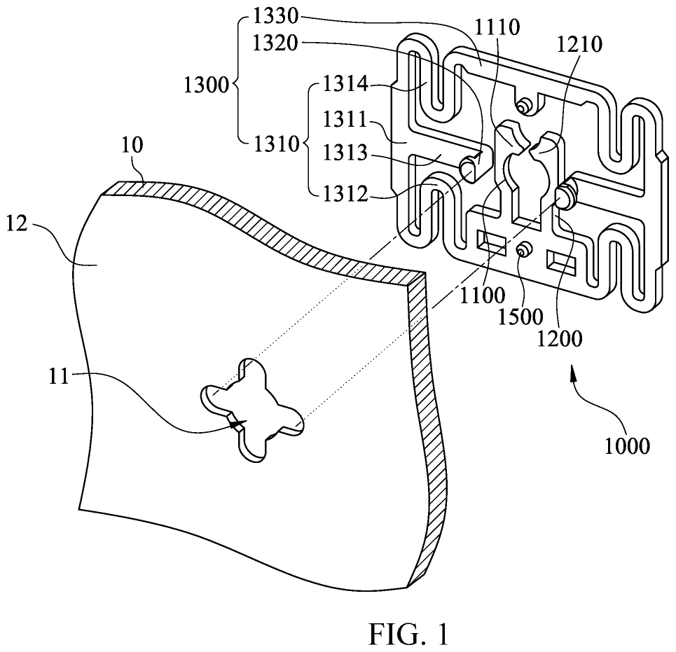

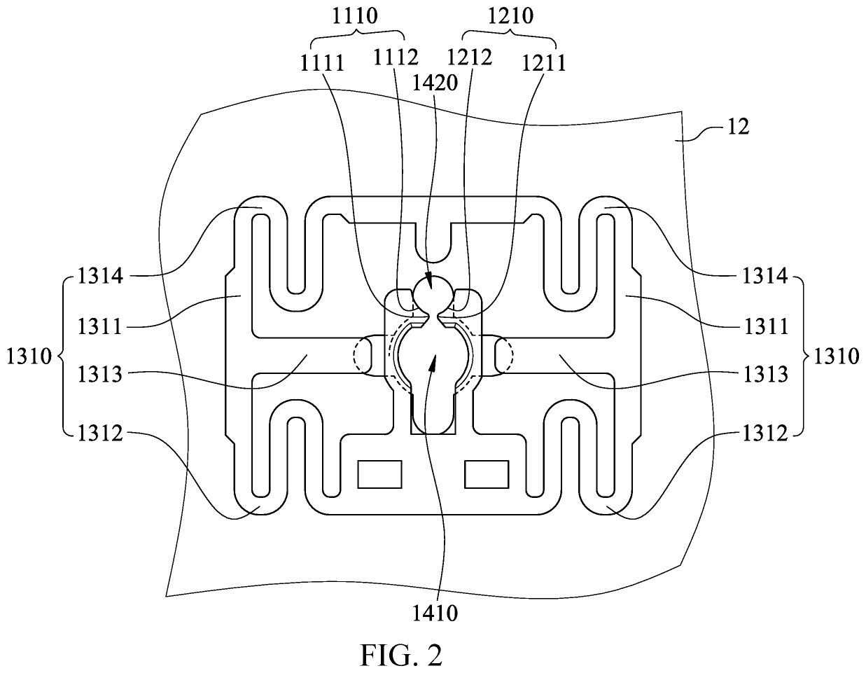

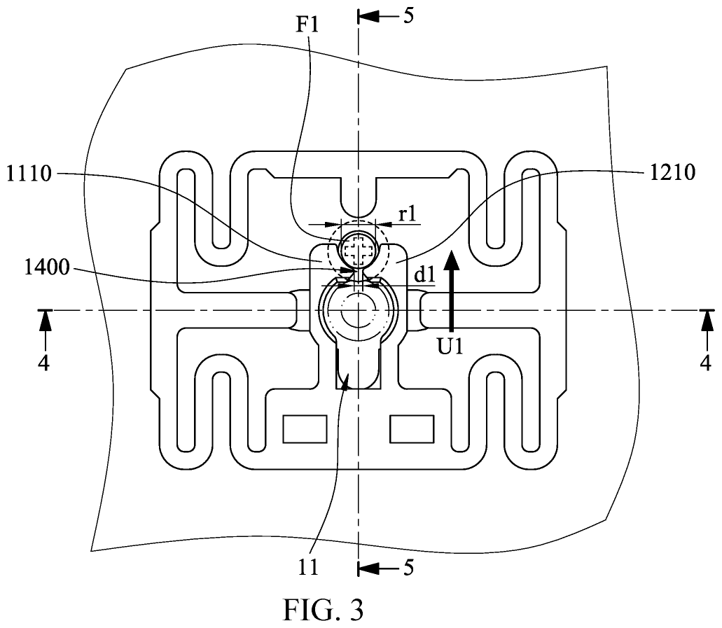

Reference is made to FIG. 1 to FIG. 3. FIG. 1 is a schematic exploded view of an auxiliary mounting device 1000 according to a first embodiment of the present disclosure coupled to a housing 10. FIG. 2 is a schematic view of the auxiliary mounting device 1000 according to the first embodiment of FIG. 1 coupled to a surface 12 of the housing 10. FIG. 3 is a schematic view of the auxiliary mounting device 1000 according to the first embodiment of FIG. 1 coupled to the housing 10 and constricting a mounting member F1. As shown in FIG. 1 to FIG. 3, the auxiliary mounting device 1000 is for coupling to a housing 10 and includes a first engaging element 1100, a second engaging element 1200 and a connecting mechanism 1300. The first engaging element 1100 has a first engaging region 1110 which is configured to partially cover a hole 11 of the housing 10. The second engaging element 1200 corresponds to the first engaging element 1100 and has a second engaging region 1210, and the second engaging region 1210 is configured to partially cover the hole 11 of the housing 10. The connecting mechanism 1300 is connected to the first engaging element 1100 and the second engaging element 1200 and is for being detachably fixed on the surface 12 of the housing 10. There is a constricting gap 1400 between the first engaging region 1110 and the second engaging region 1210. Specifically, the first engaging region 1110 extends and protrudes towards the second engaging region 1210 and forms a first protrusion point 1111, and the second engaging region 1210 extends and protrudes towards the first engaging region 1110 and forms a second protrusion point 1211 corresponding to the first protrusion point 1111. The constricting gap 1400 is formed between the first protrusion point 1111 and the second protrusion point 1211. The first engaging region 1110 and the second engaging region 1210 divide the hole 11 into an installing space 1410 and a constricting space 1420. The installing space 1410 is communicated with the constricting space 1420 through the constricting gap 1400, and the installing space 1410 is larger than the constricting space 1420. When the first engaging region 1110 and the second engaging region 1210 are expanded in opposite directions due to an external force, a width d1 of the constricting gap 1400 is changed from a first width to a second width.

The mounting member F1 passes through and is disposed in the installing space 1410. The first width is smaller than a diameter r1 of a shaft of the mounting member F1, and the second width is greater than or equal to the diameter r1 of the shaft of the mounting member F1. When the auxiliary mounting device 1000 is fixed on the surface 12 of the housing 10 by the connecting mechanism 1300, the mounting member F1 arranged on a wall surface or a flat surface can be inserted into the hole 11 of the housing 10 by the installing space 1410 formed by the first engaging region 1110 and the second engaging region 1210 which partially covering the hole 11. At this moment, because the installing space 1410 is larger than the constricting space 1420, a head and a body of the mounting member F1 are allowed to pass, and the mounting member F1 passes through and is disposed in the installing space 1410 and pushes the housing 10. Therefore, the first engaging region 1110 and the second engaging region 1210 are expanded in opposite directions due to the external force caused by the push, so that the width d1 of the constricting gap 1400 is expanded from the first width to the second width to allow the mounting member F1 to move from the installing space 1410 to the constricting space 1420 along an installation direction U1 relative to the housing 10. The first engaging region 1110 and the second engaging region 1210 subsequently resume their original shapes and positions, so that the width d1 of the constricting gap 1400 can be restored to the first width, and the mounting member F1 is limited to the constricting space 1420. Since the head of the mounting member F1 has a larger diameter, the mounting member F1 is prevented from being pulled out from the constricting space 1420 along an axis of the hole 11. When the housing 10 is shaken by other forces, the auxiliary mounting device 1000 can fix the position of the hole 11 of the housing 10 relative to the position of the mounting member F1, and the housing 10 can be avoided from falling off the mounting member F1 due to shaking. Compared with the conventional way where the mounting member F1 is directly restricted in the hole 11 by its head portion, the stability of the installation of the housing 10 can be further improved by the assistance of the auxiliary mounting device 1000. The details of the auxiliary mounting device 1000 are detailed below.

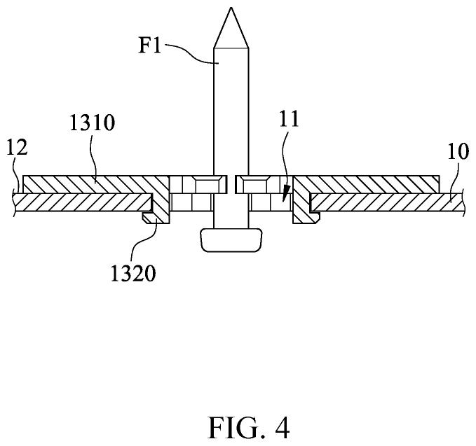

Reference is made to FIG. 1 to FIG. 4. FIG. 4 is a schematic cross-sectional view along Line 4-4 of the auxiliary mounting device 1000 according to the first embodiment of FIG. 3. The connecting mechanism 1300 can include two elastic elements 1310 and two hook elements 1320. Two elastic elements 1310 are respectively adjacent to the first engaging element 1100 and the second engaging element 1200. In other words, one of the elastic elements 1310 is adjacent to the first engaging element 1100, and the other one of the elastic elements 1310 is adjacent to the second engaging element 1200. The two hook elements 1320 are respectively connected to the two elastic elements 1310. When the two elastic elements 1310 are deformed by force, a distance between the two hook elements 1320 is decreased, so that the two hook elements 1320 can enter the hole 11. When the elastic elements 1310 resume their original shapes and positions, the two hook elements 1320 are wedged at two ends of the hole 11. A user can press the elastic elements 1310 to allow the hook elements 1320 to enter the hole 11. After the hook elements 1320 enter the hole 11, the user can stop applying force compression so that the elastic elements 1310 resume their original shapes and positions and drive the hook elements 1320 to expand away from each other. Thus, the hook elements 1320 are wedged at the two ends of the hole 11 so as to fix the auxiliary mounting device 1000 on the surface 12 of the housing 10. Furthermore, when the auxiliary mounting device 1000 is fixed on the surface 12, the user can press the elastic elements 1310 again, and the hook elements 1320 is away from the hole 11 so as to facilitate the disassembly of the auxiliary mounting device 1000. Therefore, the convenience of disassembly and installation of the auxiliary mounting device 1000 can be enhanced. Specifically, the hole 11 can be cross-shaped, but the present disclosure is not limited thereto. The two hook elements 1320 are engaged with two opposite ends of four ends of the hole 11 with the cross-shape. When the housing 10 is shaken by the force, the possibility that the hook elements 1320 comes out of the hole 11 can be reduced by the hole 11 with the cross-shape. Therefore, the stability of the auxiliary mounting device 1000 fixed on the surface 12 can be further enhanced.

As shown in FIG. 1 to FIG. 4, each of the elastic elements 1310 can include a press region 1311, a first bending region 1312, a straight region 1313 and a second bending region 1314. The first bending region 1312 is connected between the press region 1311 and the respective one of the first engaging element 1100 and the second engaging element 1200, and the straight region 1313 is connected between the press region 1311 and the respective one of the two hook elements 1320. In detail, the first bending region 1312 of one of the elastic elements 1310 is connected between the press region 1311 of the one of the elastic elements 1310 and the first engaging element 1100, and the first bending region 1312 of the other one of the elastic elements 1310 is connected between the press region 1311 of the other one of the elastic elements 1310 and the second engaging element 1200. The straight region 1313 of each of the elastic elements 1310 is connected between the press region 1311 of each of the elastic elements 1310 and each of the hook elements 1320. The user can respectively press the press regions 1311 of the two elastic elements 1310 to compress the first bending regions 1312 so as to cause the two straight regions 1313 to approach each other, and a distance between the two hook elements 1320 can be shortened, thereby allowing the hook elements 1320 to enter or exit the hole 11.

The connecting mechanism 1300 can further include a connecting region 1330. The second bending region 1314 of each of the elastic elements 1310 is connected to the press region 1311 thereof, and the connecting region 1330 is connected between the two second bending regions 1314. Two ends of the press region 1311 are respectively connected to the first bending region 1312 and the second bending region 1314. When the user exerts force on the press regions 1311, the first bending regions 1312 and the second bending regions 1314 are compressed by the force simultaneously, and the straight regions 1313 are restrained to approach each other along a horizontal connecting line of the two hook elements 1320, so that the shortened direction and distance of the two hook elements 1320 can be stabilized, and the stability of disassembly or installation can be enhanced.

Further, the connecting mechanism 1300, the first engaging element 1100 and the second engaging element 1200 can be connected and integrally formed into a plate-shaped structure. That is, the press region 1311, the first bending region 1312, the straight region 1313, the second bending region 1314, the hook elements 1320 and the connecting region 1330 are all integrally formed. Therefore, the manufacturing process of the auxiliary mounting device 1000 can be simplified, the manufacturing cost can be reduced, and the structural strength can be further enhanced. The connecting mechanism 1300, the first engaging element 1100 and the second engaging element 1200 can be made of plastic material or metal material. In the first embodiment, the connecting mechanism 1300, the first engaging element 1100 and the second engaging element 1200 are made of plastic material, but the present disclosure is not limited thereto.

As shown in FIG. 2 and FIG. 3, the first engaging region 1110 can have a first arc line 1112, the second engaging region 1210 can have a second arc line 1212, and the first arc line 1112, the second arc line 1212 and a part of the hole 11 form the constricting space 1420. The first arc line 1112 and the second arc line 1212 correspond to the shape of the shaft of the mounting member F1. The diameter r1 of the mounting member F1 is greater than the first width of the constricting gap 1400, and the second width of the constricting gap 1400 is greater than or equal to the diameter r1 of the mounting member F1. When the mounting member F1 is constrained in the constricting space 1420, the shapes of the first arc line 1112 and the second arc line 1212 can further increase the stability of the constriction so as to avoid the mounting member F1 from falling out of the constricting space 1420.

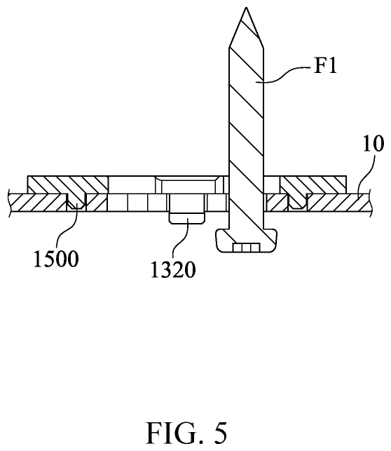

Reference is made to FIG. 5. FIG. 5 is a schematic cross-sectional view along Line 5-5 of the auxiliary mounting device 1000 according to the first embodiment of FIG. 3. As shown in FIG. 5, the auxiliary mounting device 1000 can further include at least one positioning protrusion 1500 that is integrally connected to the plate-shaped structure formed by the connecting mechanism 1300, the first engaging element 1100 and the second engaging element 1200, and the positioning protrusion 1500 protrudes from the plate-shaped structure. The positioning protrusion 1500 is for engaging with a positioning groove of the housing 10 so as to reduce the possibility that the auxiliary mounting device 1000 falls off from the housing 10 due to shaking, and the stability of the auxiliary mounting device 1000 coupled to the housing 10 can be further enhanced. Further, after the mounting member F1 enters the constricting space 1420, as shown in FIG. 5, the head of the mounting member F1 can be partially blocked by the housing 10, and the mounting member F1 can be further prevented from being pulled out of the constricting space 1420 along the axis of the hole 11.

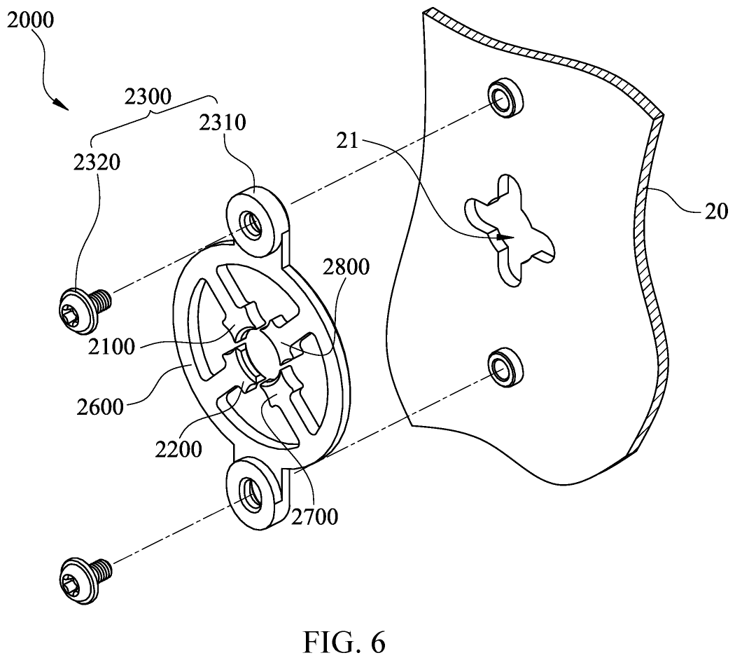

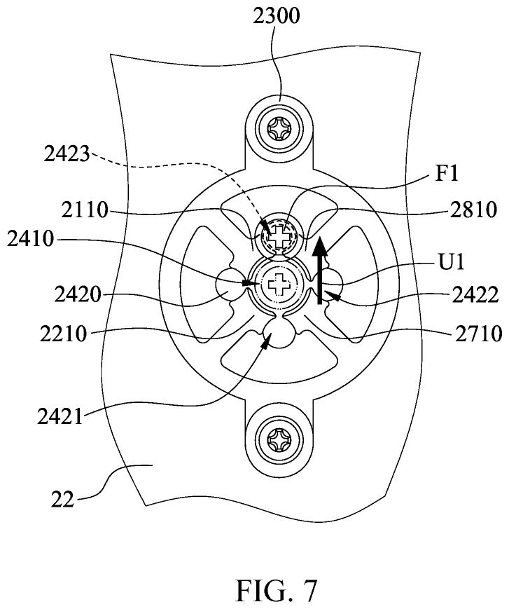

Reference is made to FIG. 6 and FIG. 7. FIG. 6 is a schematic exploded view of an auxiliary mounting device 2000 according to a second embodiment of the present disclosure coupled to a housing 20, and FIG. 7 is a schematic view of the auxiliary mounting device 2000 according to the second embodiment of FIG. 6 coupled to the housing 20 and constricting a mounting member F1. In the second embodiment, the structure of the auxiliary mounting device 2000 is similar to that of the auxiliary mounting device 1000, and the difference is that the auxiliary mounting device 2000 further includes a ring 2600, a third engaging element 2700 and a fourth engaging element 2800. The ring 2600 is for connecting the first engaging element 2100 and the second engaging element 2200, and the first engaging element 2100 and the second engaging element 2200 radially extend and protrude inward from the ring 2600. The third engaging element 2700 radially extends and protrudes inward from the ring 2600 and has a third engaging region 2710, and the third engaging region 2710 is configured to partially cover the hole 21 of the housing 20. The fourth engaging element 2800 radially extends and protrudes inward from the ring 2600 and has a fourth engaging region 2810, and the fourth engaging region 2810 is configured to partially cover the hole 21 of the housing 20. The first engaging element 2100, the second engaging element 2200, the third engaging element 2700 and the fourth engaging element 2800 are spaced apart (arranged at intervals). A number of the constricting gap is a plural, each of the constricting gaps is formed between each two adjacent engaging regions of the first engaging region 2110, the second engaging region 2210, the third engaging region 2710 and the fourth engaging region 2810. A number of the constricting space 2420, 2421, 2422, 2423 is a plural, each of the constricting space 2420, 2421, 2422, 2423 is formed by each two of the adjacent engaging regions and the hole 21. In detail, a constricting gap is formed between the first engaging region 2110 and the second engaging region 2210, and a constricting space 2420 is formed by the first engaging region 2110, the second engaging region 2210 and the hole 21. Another constricting gap is formed between the second engaging region 2210 and the third engaging region 2710, and another constricting space 2421 is formed by the second engaging region 2210, the third engaging region 2710 and the hole 21. Another constricting gap is formed between the third engaging region 2710 and the fourth engaging region 2810, and another constricting space 2422 is formed by the third engaging region 2710, the fourth engaging region 2810 and the hole 21. As well, another constricting gap is formed between the fourth engaging region 2810 and the first engaging region 2110, and another constricting space 2423 is formed by the fourth engaging region 2810, the first engaging region 2110 and the hole 21. The first engaging region 2110, the second engaging region 2210, the third engaging region 2710 and the fourth engaging region 2810 surround and form the installing space 2410. By the configuration of the ring 2600, the first engaging element 2100, the second engaging element 2200, the third engaging element 2700 and the fourth engaging element 2800 can protrude inwardly in the ring 2600 and form four constricting spaces 2420, 2421, 2422, 2423, and the four constricting spaces 2420, 2421, 2422, 2423 can be respectively located at four ends of the hole 21 with the cross-shape. Thus, the mounting member F1 can be constrained in one of the constricting spaces 2420, 2421, 2422, 2423 (for example, the constricting space 2423 shown in FIG. 7) along the installation direction U1 according to the user's needs so as to increase the convenience of installation.

The connecting mechanism 2300 can include two mounting seats 2310 and two fastening members 2320. Each of the mounting seats 2310 is connected to the ring 2600 and radially extends and protrudes outward, and each of the fastening members 2320 is used to pass through each of the mounting seats 2310 and fasten to the housing 20. By fastening the fastening members 2320 to the surface 22 of the housing 20, the stability of the auxiliary mounting device 2000 coupled to the housing 20 can be further enhanced. In the second embodiment, the connecting mechanism 2300 is fixed on the surface 22 inside the housing 20 so as to avoid the possibility that the auxiliary mounting device 2000 is damaged due to the external environment.

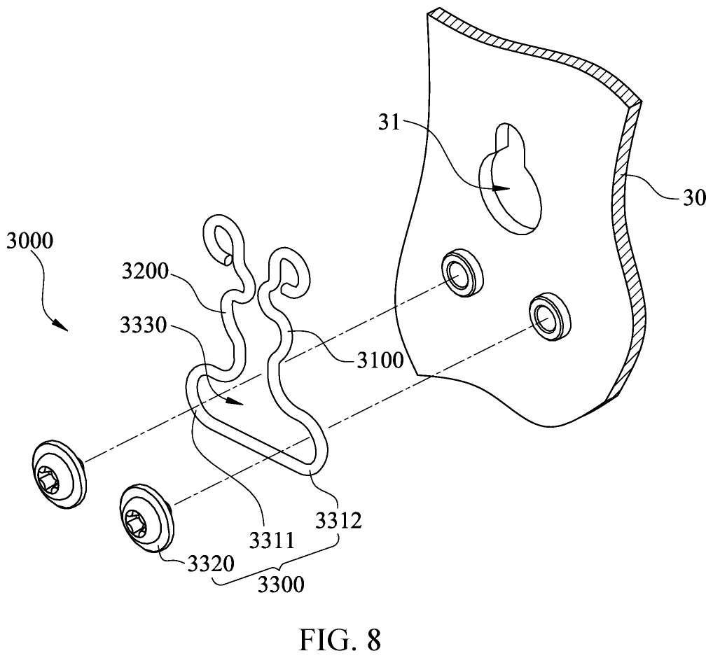

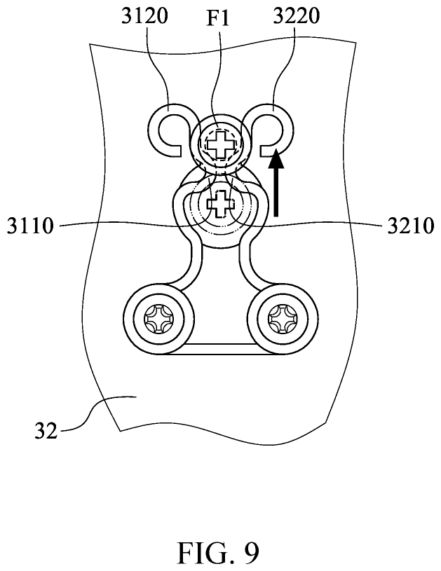

Reference is made to FIG. 8 and FIG. 9. FIG. 8 is a schematic exploded view of an auxiliary mounting device 3000 according to a third embodiment of the present disclosure coupled to a housing 30, and FIG. 9 is a schematic view of the auxiliary mounting device 3000 according to the third embodiment of FIG. 8 coupled to the housing 30 and constricting a mounting member F1. In the third embodiment, the structure of the auxiliary mounting device 3000 is similar to that of the auxiliary mounting device 1000, and the differences are that the first engaging element 3100 of the auxiliary mounting device 3000 includes a first curving region 3120, and the second bending element 3200 includes a second curving region 3220. The first curving region 3120 is integrally connected to the first engaging region 3110 and is away from the connecting mechanism 3300, and the second curving region 3220 is integrally connected to the second engaging region 3210 and is away from the connecting mechanism 3300. The first curving region 3120 and the second curving region 3220 are attached to the surface 32. Furthermore, the hole 31 of the housing 30 is gourd-shaped or keyhole-shaped, the first engaging region 3110 and the second engaging region 3210 divide the hole 31 with the gourd-shape into an installing space and a constricting space, and the installing space is larger than the constricting space.

When the mounting member F1 is moved from the installing space to the constricting space, the configuration of the first curving region 3120 and the second curving region 3220 can limit the expansion amplitude of the first engaging region 3110 and the second curving region 3220 when under force. Therefore, the manufacturing process of the auxiliary mounting device 3000 can be simplified, and the installation stability can be improved.

The connecting mechanism 3300 can include two ribs 3311, 3312 and two fastening members 3320. The rib 3311 is connected to the first engaging element 3100, and the rib 3312 is connected to the second engaging element 3200 and the rib 3311 to surround and form a fastening space 3330. The fastening members 3320 enter the fastening space 3330 to fasten to the housing 30 and respectively abut against the ribs 3311, 3312. Thus, the manufacturing process of the connecting mechanism 3300 can be simplified, and the stability of the connecting mechanism 3300 fixed to the housing 30 can be enhanced.

Specifically, the two ribs 3311, 3312, the first engaging element 3100 and the second engaging element 3200 can be integrally formed by rigid wire material. Therefore, the auxiliary mounting device 3000 can be made of a single wire material, the manufacturing process can be simplified, and the manufacturing costs can be reduced.

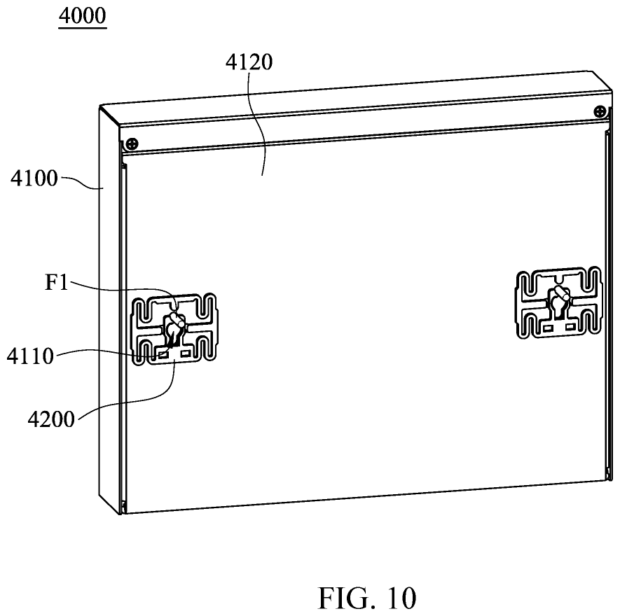

Reference is made to FIG. 10. FIG. 10 is a three-dimensional schematic view of a mounting system 4000 according to a fourth embodiment of the present disclosure constricting a mounting member F1. The mounting system 4000 is used for constricting the mounting member F1 and includes a housing 4100 and an auxiliary mounting device 4200. The auxiliary mounting device 4200 can be similar to the auxiliary mounting device 1000 of the first embodiment, but the present disclosure is not limited thereto. The housing 4100 includes a surface 4120 and a hole 4110, and the hole 4110 is disposed on the surface 4120 of the housing 4100 and is configured for the mounting member F1 to pass through. The surface 4120 can be an outer surface of the housing 4100. However, in other embodiments, the surface can be an inner surface of the housing, that is, the auxiliary mounting device is installed inside the housing, but the present disclosure is not limited thereto. The configuration of the auxiliary mounting device 4200 assists the user to move the hole 4110 of the housing 4100 to the position where the mounting member F1 passes, so that the mounting member F1 enters the installing space, and then the user can move the housing 4100 to allow the mounting member F1 move relative to the housing 4100 along an installation direction. When the mounting member F1 moves relative to the housing 4100 along the installation direction, the first engaging region and the second engaging region of the auxiliary mounting device 4200 are expanded in opposite directions due to an external force, and the width of the constricting gap between the first engaging region and the second engaging region is changed from the first width to the second width so as to allow the mounting member F1 to pass through the constricting gap. After the first engaging region and the second engaging region resume their original place, the mounting member F1 is constrained to the constricting space, so that the stability of the mounting system 4000 installed on the mounting member F1 can be enhanced.

In the embodiments of the present disclosure, the mounting member can be a pole, a rod, a shaft, the housing can be a case, and the fastening member can be a screw, but the present disclosure is not limited thereby.

In summary, the present disclosure has the following advantages. First, the hole is divided into the installing space and the constricting space by the first engaging region and the second engaging region, and the mounting member is limited to the constricting space, so that the stability of the housing fixed on the mounting member can be enhanced. Second, it is favorable for users to disassemble or assemble the auxiliary mounting devices by the configuration of the hook elements and the elastic elements. Third, by the arrangement of one-piece plate-shaped structure, the manufacturing process of the auxiliary mounting device can be simplified, and the manufacturing cost can be reduced.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An auxiliary mounting device, comprising:
a first engaging element having a first engaging region for partially covering a hole of a housing;
a second engaging element corresponding to the first engaging element and having a second engaging region for partially covering the hole of the housing; and
a connecting mechanism connected to the first engaging element and the second engaging element and for being detachably fixed on a surface of the housing;
wherein the first engaging region and the second engaging region divide the hole into an installing space and a constricting space, the installing space is communicated with the constricting space through a constricting gap between the first engaging region and the second engaging region, and the installing space is larger than the constricting space;
wherein when the first engaging region and the second engaging region are expanded in opposite directions due to an external force, a width of the constricting gap is changed from a first width to a second width.

2. The auxiliary mounting device of claim 1, wherein the connecting mechanism comprises:
two elastic elements respectively adjacent to the first engaging element and the second engaging element; and
two hook elements respectively connected to the two elastic elements;
wherein when the two elastic elements are deformed, a distance between the two hook elements is decreased, so the two hook elements enter the hole;
wherein when the two elastic elements resume, the two hook elements are wedged at two ends of the hole.

3. The auxiliary mounting device of claim 2, wherein each of the two elastic elements comprises a press region, a first bending region and a straight region, the first bending region of one of the two elastic elements is connected between the press region of the one of the two elastic elements and the first engaging element, the first bending region of the other one of the two elastic elements is connected between the press region of the other one of the two elastic elements and the second engaging element, and the straight region of each of the two elastic elements is connected between the press region of each of the two elastic elements and each of the two hook elements.

4. The auxiliary mounting device of claim 3, wherein each of the two elastic elements further comprises a second bending region, the connecting mechanism further comprises a connecting region, the second bending region of each of the two elastic elements is connected to the press region thereof, and the connecting region is connected between the two second bending regions.

5. The auxiliary mounting device of claim 1, wherein the connecting mechanism, the first engaging element and the second engaging element are integrally formed into a plate-shaped structure.

6. The auxiliary mounting device of claim 5, wherein the connecting mechanism, the first engaging element and the second engaging element are made of plastic material or metal material.

7. The auxiliary mounting device of claim 1, wherein the first engaging region has a first arc line, the second engaging region has a second arc line, and the constricting space is formed by the first arc line, the second arc line and a part of the hole.

8. The auxiliary mounting device of claim 1, further comprising:
a ring for connecting the first engaging element and the second engaging element, and the first engaging element and the second engaging element extending radially inward from the ring;
a third engaging element extending radially inward from the ring and having a third engaging region for partially covering the hole of the housing; and
a fourth engaging element extending radially inward from the ring and having a fourth engaging region for partially covering the hole of the housing;
wherein the first engaging element, the second engaging element, the third engaging element and the fourth engaging element are spaced apart, a number of the constricting gap is a plural, each of the constricting gaps is formed between each two adjacent engaging regions of the first engaging region, the second engaging region, the third engaging region and the fourth engaging region, a number of the constricting space is a plural, each of the constricting spaces is formed by each two of the adjacent engaging regions and the hole, and and the fourth engaging region form the installing space.

9. The auxiliary mounting device of claim 8, wherein the connecting mechanism comprises two mounting seats and two fastening members, each of the two mounting seats is connected to the ring and extends radially outward, and each of the two fastening members is for passing through each of the two mounting seats and fastening to the housing.

10. The auxiliary mounting device of claim 1, wherein the first engaging element further comprises a first curving region, the first curving region is integrally connected to the first engaging region and away from the connecting mechanism, the second engaging element further comprises a second curving region, the second curving region is integrally connected to the second engaging region and away from the connecting mechanism, and the first curving region and the second curving region are attached to the surface.

11. The auxiliary mounting device of claim 1, wherein the connecting mechanism comprises two ribs and two fastening members, one of the two ribs is connected to the first engaging element, another one of the two ribs is connected to the second engaging element and the one of the two ribs to form a fastening space, and the two fastening members enter the fastening space to fasten to the housing and respectively abut against the two ribs.

12. The auxiliary mounting device of claim 11, wherein the two ribs, the first engaging element and the second engaging element are integrally formed by rigid wire material.

13. A mounting system, comprising:
a housing comprising a surface and a hole disposed on the surface of the housing; and
an auxiliary mounting device, comprising:
a first engaging element having a first engaging region for partially covering the hole of the housing;
a second engaging element corresponding to the first engaging element and having a second engaging region for partially covering the hole of the housing; and
a connecting mechanism connected to the first engaging element and the second engaging element and for being detachably fixed on the surface of the housing;
wherein the first engaging region and the second engaging region divide the hole into an installing space and a constricting space, the installing space is communicated with the constricting space through a constricting gap between the first engaging region and the second engaging region, and the installing space is larger than the constricting space;
wherein when a mounting member passes through and is disposed in the installing space and is moved relative to the housing along an installing direction, the first engaging region and the second engaging region are expanded in opposite directions due to an external force, and a width of the constricting gap is changed from a first width to a second width;
wherein the first width is smaller than a diameter of the mounting member, the second width is greater than or equal to the diameter of the mounting member, so the mounting member passes through the constricting gap, and the mounting member is constricted to the constricting space after the first engaging region and the second engaging region resume.

14. The mounting system of claim 13, wherein the surface is an outer surface or an inner surface of the housing.

15. The mounting system of claim 13, wherein the hole is cross-shaped.

16. The mounting system of claim 15, wherein the connecting mechanism comprises:
two elastic elements respectively adjacent to the first engaging element and the second engaging element; and
two hook elements respectively connected to the two elastic elements;
wherein when the two elastic elements are deformed, a distance between the two hook elements is decreased, so the two hook elements enter the hole;
wherein when the two elastic elements resume, the two hook elements are wedged at two ends of the hole.

17. The mounting system of claim 16, wherein each of the two elastic elements comprises a press region, a first bending region and a straight region, the first bending region of one of the two elastic elements is connected between the press region of the one of the two elastic elements and the first engaging element, the first bending region of the other one of the two elastic elements is connected between the press region of the other one of the two elastic elements and the second engaging element, and the straight region of each of the two elastic elements is connected between the press region of each of the two elastic elements and each of the two hook elements.

18. The mounting system of claim 13, wherein the auxiliary mounting device further comprises:
a ring for connecting the first engaging element and the second engaging element, and the first engaging element and the second engaging element extending radially inward from the ring;
a third engaging element extending radially inward from the ring and having a third engaging region for partially covering the hole of the housing; and
a fourth engaging element extending radially inward from the ring and having a fourth engaging region for partially covering the hole of the housing;
wherein the first engaging element, the second engaging element, the third engaging element and the fourth engaging element are spaced apart, a number of the constricting gap is a plural, each of the constricting gaps is formed between each two adjacent engaging regions of the first engaging region, the second engaging region, the third engaging region and the fourth engaging region, a number of the constricting space is a plural, each of the constricting spaces is formed by each two of the adjacent engaging regions and the hole, and and the fourth engaging region form the installing space.

19. The mounting system of claim 13, wherein the connecting mechanism comprises two ribs and two fastening members, one of the two ribs is connected to the first engaging element, another one of the two ribs is connected to the second engaging element and the one of the two ribs to form a fastening space, the two fastening members enter the fastening space to fasten to the housing and respectively abut against the two ribs, and the two ribs, the first engaging element and the second engaging element are integrally formed by rigid wire material.

20. The mounting system of claim 13, wherein the connecting mechanism, the first engaging element and the second engaging element are connected and integrally formed into a plate-shaped structure, the auxiliary mounting device further comprises at least one positioning protrusion protruding from the plate-shaped structure, and the at least one positioning protrusion is for engaging with a positioning groove of the housing.
